(19) United States
(12) Patent Application Publication
(10) Pub. No.: US 2007/0047644 A1
(43) Pub. Date: Mar. 1, 2007

(54) Method for enhancing performance of residual prediction and video encoder and decoder using the same

(75) Inventors: Kyo-hyuk Lee, Seoul (KR); Mathew Manu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/508,951

(22) Filed: Aug. 24, 2006

Related U.S. Application Data
(60) Provisional application No. 60/710,613, filed on Aug. 24, 2005.

(30) Foreign Application Priority Data
Dec. 8, 2005 (KR) 10-2005-0119785

(51) Int. Cl. H04B 1/66; H04N 11/04

(52) U.S. Cl. 375/240.1; 375/240.24

(57) ABSTRACT

A method and apparatus for enhancing the performance of residual prediction in a multi-layered video codec are provided. A residual prediction method includes calculating a first residual signal for a current layer block; calculating a second residual signal for a lower layer block corresponding to the current layer block; performing scaling by multiplying the second residual signal by a scaling factor; and calculating a difference between the first residual signal and the scaled second residual signal.

### CROSS-REFERENCE TO RELATED APPLICATION

This application claims priority from Korean Patent Application No. 10-2005-0119785 filed on Dec. 8, 2005 in the Korean Intellectual Property Office, and U.S. Provisional Patent Application No. 60/710,613 filed on Aug. 24, 2005 in the U.S. Patent and Trademark Office, the whole disclosures of which are incorporated herein by reference in their entirety.

### BACKGROUND OF THE INVENTION

1. Field of the Invention

Methods and apparatuses consistent with the present invention relate to a video compression technique, and more particularly, to enhancing the performance of residual prediction in a multi-layered video codec.

2. Description of the Related Art

With the development of information communication technology, including the Internet, video communication as well as text and voice communication, has increased dramatically. Conventional text communication cannot satisfy users' various demands, and thus, multimedia services that can provide various types of information such as text, pictures, and music have increased. However, multimedia data requires a storage media that has a large capacity and a wide bandwidth for transmission since the amount of multimedia data is usually large. Accordingly, a compression coding method is requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or repeated sounds in audio, or mental visual redundancy which takes into account human eyesight and its limited perception of high frequency. In general video coding, temporal redundancy is removed by motion compensation based on motion estimation and compensation, and spatial redundancy is removed by transform coding.

To transmit multimedia generated after removing data redundancy, transmission media are used. Transmission performance is different depending on the transmission media. Transmission media, which are currently in use, have various transmission rates. For example, an ultrahigh-speed communication network can transmit data of several tens of megabits per second while a mobile communication network has a transmission rate of 384 kilobits per second. Accordingly, to support transmission media having various speeds or to transmit multimedia at a data rate suitable for a given transmission environment, data coding methods which have scalability, such as wavelet video coding and subband video coding, may be used.

Scalability indicates a characteristic that enables a decoder or a pre-decoder to partially decode a single compressed bitstream according to various conditions such as a bit rate, an error rate, and system resources. A decoder or a pre-decoder can reconstruct a multimedia sequence having different picture quality, resolutions, or frame rates using only a portion of a bitstream that has been coded according to a method which has scalability.

Moving Picture Experts Group-21 (MPEG-21) Part 13 standardization for scalable video coding is under way. In particular, much effort is being made to implement scalability based on a multi-layered structure. For example, a bitstream may consist of multiple layers, i.e., base layer and first and second enhanced layers with different resolutions, i.e. quarter common intermediate format (QCIF), common intermediate format (CIF), and twice common interchange/intermediate format (2CIF), or frame rates.

FIG. 1 illustrates an example of a scalable video coding scheme using a multi-layered structure. In the scalable video coding scheme shown in FIG. 1, a base layer has a QCIF resolution and a frame rate of 15 Hz, a first enhanced layer has a CIF resolution and a frame rate of 30 Hz, and a second enhanced layer has a standard definition (SD) resolution and a frame rate of 60 Hz.

Interlayer correlation may be used in encoding a multi-layer video frame. For example, a region 12 in a first enhancement layer video frame may be efficiently encoded using prediction from a corresponding region 13 in a base layer video frame. Similarly, a region 11 in a second enhancement layer video frame can be efficiently encoded using prediction from the region 12 in the first enhancement layer. When each layer of a multi-layer video has a different resolution, an image of the base layer needs to be upsampled before the prediction is performed.

In a Scalable Video Coding (SVC) standard that is currently under development by Joint Video Team (JVT) of International Organization for Standardization/International Electrotechnical Commission (ISO/IEC) and International Telecommunication Union (ITU), research into multi-layer coding as illustrated in FIG. 1 based on conventional H.264 has been actively conducted.

The SVC standard using a multi-layer structure supports intra base layer (BL) prediction and residual prediction in addition to directional intra prediction and inter prediction used in the conventional H.264 to predict a block or macroblock in a current frame.

The residual prediction involves predicting a residual signal in a current layer from a residual signal in a lower layer and quantizing only a signal corresponding to a difference between the predicted value and the actual value.

FIG. 2 is an exemplary diagram illustrating a residual prediction process defined in the SVC standard.

First, in step S1, a predicted block P_{B} for a block O_{B} in a lower layer N-1 is generated using neighboring frames. In step S2, the predicted block P_{B} is subtracted from the block O_{B} to generate residual R_{B}. In step S3, the residual R_{B} is subjected to quantization/inverse quantization to generate a reconstructed residual R_{B}′.

In step S4, a predicted block P_{C} for a block O_{C} in a current layer N is generated using neighboring frames. In step S5, the predicted block P_{C} is subtracted from the block O_{C} to generate residual R_{C}.

In step S6, the residual R_{C} obtained in the step S4 is subtracted from the reconstructed residual R_{B}′, and in step S7, the subtraction result R obtained in the step S6 is quantized.

However, the conventional residual prediction process has a drawback in that a residual signal energy is not sufficiently removed in a subtraction step of the residual prediction process because the residual signal R_{B} has a different dynamic range (or error range) from the residual signal R_{C} when a quantization parameter for a reference frame used in generating the current layer predicted signal P_{C} is different from a quantization parameter for a reference frame used in generating the lower layer predicted signal P_{B}, as shown in FIG. 3.

That is to say, although an original image signal in the current layer is similar to an original image signal in the lower layer, the predicted signals P_{B} and P_{C} for predicting the original image signals may vary according to the quantization parameters of the current layer and the lower layer. Accordingly, the variable residual signals R_{B} and R_{C} may not be sufficiently removed.

### SUMMARY OF THE INVENTION

An aspect of the present invention is to provide a method for reducing a quantity of coded data by reducing residual signal energy in residual prediction used in a multi-layered video codec.

Another aspect of the present invention is to provide an improved video encoder and video decoder employing the method.

These and other aspects of the present invention will be described in or be apparent from the following description of exemplary embodiments of the invention.

According to an exemplary embodiment of the present invention, there is provided a residual prediction method including calculating a first residual signal for a current layer block; calculating a second residual signal for a lower layer block corresponding to the current layer block, performing scaling by multiplying the second residual signal by a scaling factor, and calculating a difference between the first residual signal and the scaled second residual signal.

According to another exemplary embodiment of the present invention, there is provided a multi-layer video encoding method including calculating a first residual signal for a current layer block, calculating a second residual signal for a lower layer block corresponding to the current layer block, performing scaling by multiplying the second residual signal by a scaling factor, and calculating a difference between the first residual signal and the scaled second residual signal, and quantizing the difference.

According to still another exemplary embodiment of the present invention, there is provided a method for generating a multi-layer video bitstream including generating a base layer bitstream and generating an enhancement layer bitstream, wherein the enhancement layer bitstream contains at least one macroblock and each macroblock comprises a field indicating a motion vector, a field specifying a coded residual, and a field indicating a scaling factor for the macroblock, and wherein the scaling factor is used to make a dynamic range of a residual signal for a base layer block substantially equal to a dynamic range of a residual signal for an enhancement layer block.

According to yet another exemplary embodiment of the present invention, there is provided a multi-layer video decoding method including reconstructing a difference signal for a current layer block from an input bitstream, reconstructing a first residual signal for a lower layer block from the input bitstream, performing scaling by multiplying the first residual signal by a scaling factor, and adding the reconstructed difference signal and the scaled first residual signal together and reconstructing a second residual signal for the current layer block.

According to a further exemplary embodiment of the present invention, there is provided a multi-layer video encoder including means for calculating a first residual signal for a current layer block, means for calculating a second residual signal for a lower layer block corresponding to the current layer block, means for performing scaling by multiplying the second residual signal by a scaling factor, means for calculating a difference between the first residual signal and the scaled second residual signal, and means for quantizing the difference.

According to yet a further exemplary embodiment of the present invention, there is provided a multi-layer video decoder including means for reconstructing a difference signal for a current layer block from an input bitstream, means for reconstructing a first residual signal for a lower layer block from the input bitstream, means for performing scaling by multiplying the first residual signal by a scaling factor, and means for adding the reconstructed difference signal and the scaled first residual signal together and reconstructing a second residual signal for the current layer block.

### BRIEF DESCRIPTION OF THE DRAWINGS

The above and other aspects of the present invention will become more apparent by describing in detail exemplary embodiments thereof with reference to the attached drawings in which:

FIG. 1 is an exemplary diagram illustrating a conventional scalable video coding (SVC) scheme using a multi-layer structure;

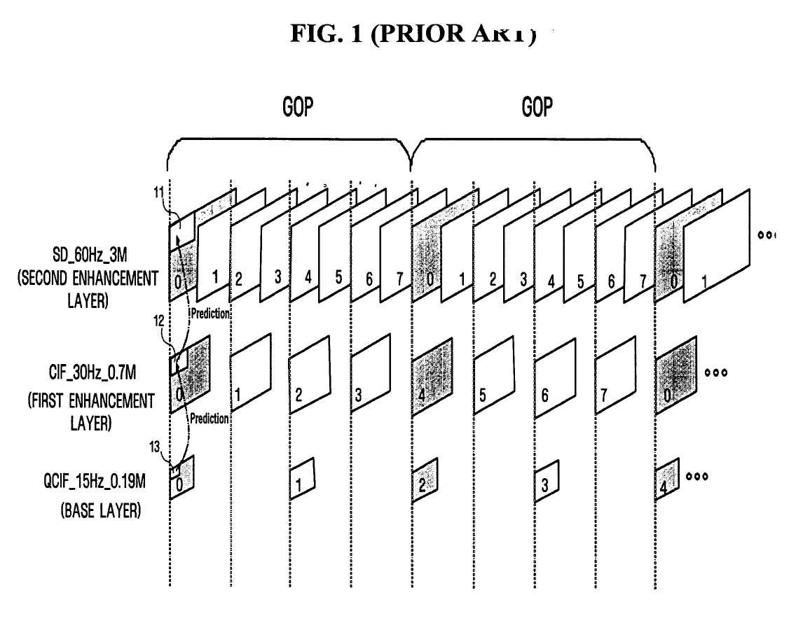

FIG. 2 is an exemplary diagram illustrating a residual prediction process defined in a conventional SVC standard;

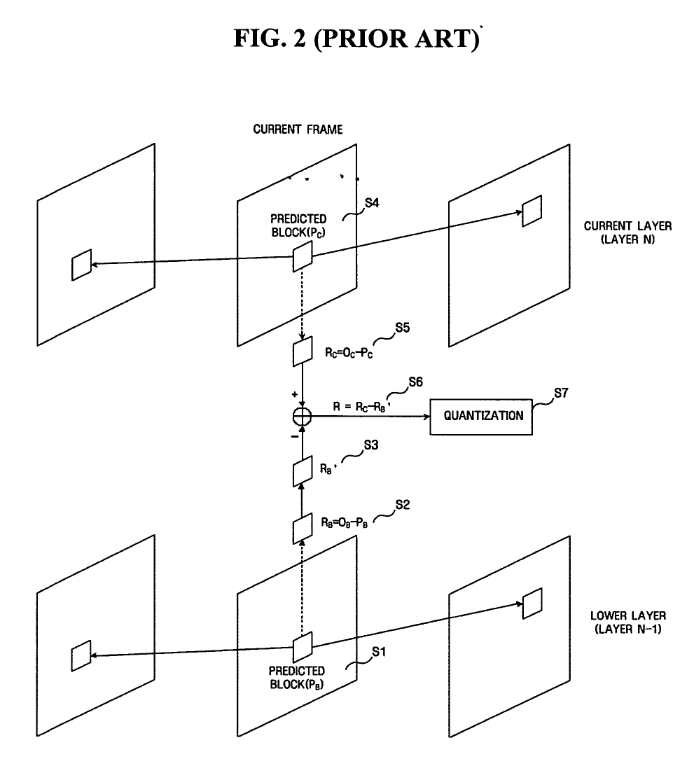

FIG. 3 illustrates a dynamic range for a residual signal of the residual prediction process of FIG. 2 that varies for each layer;

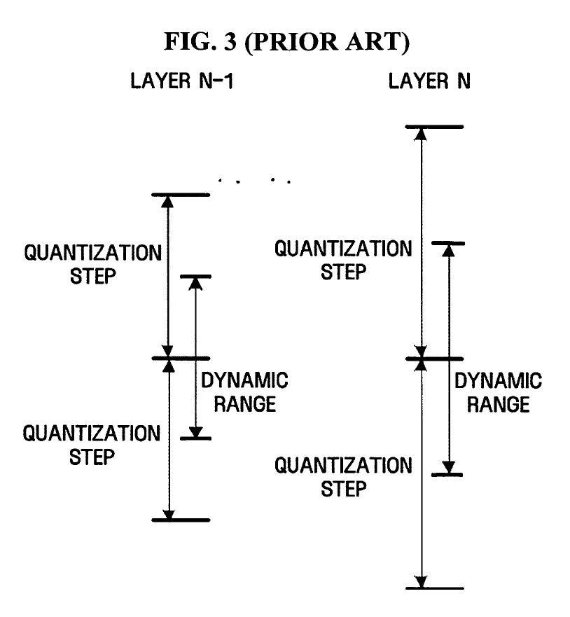

FIG. 4 illustrates a residual prediction process according to an exemplary embodiment of the present invention;

FIG. 5 illustrates an example of calculating a motion block representing parameter;

FIG. 6 is a diagram of a multi-layer video encoder according to an exemplary embodiment of the present invention;

FIG. 7 illustrates the structure of a bitstream generated by the video encoder of FIG. 6;

FIG. 8 is a diagram of a multi-layer video decoder according to an exemplary embodiment of the present invention; and

FIG. 9 is a diagram of a multi-layer video decoder according to another exemplary embodiment of the present invention.

### DETAILED DESCRIPTION OF EXEMPLARY EMBODIMENTS OF THE PRESENT INVENTION

Exemplary embodiments of the present invention will now be described more fully with reference to the accompanying drawings, in which exemplary embodiments of the invention are shown. Various advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

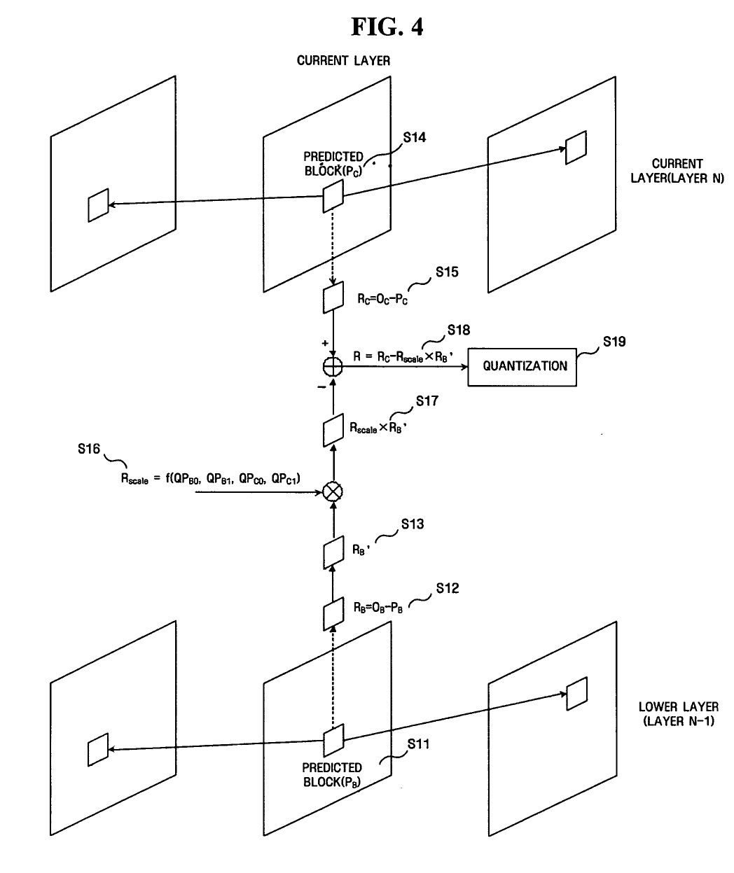

FIG. 4 illustrates a residual prediction process according to an exemplary embodiment of the present invention.

In step S11, a predicted block P_{B} for a block O_{B} in a lower layer N-1 is generated using neighboring frames (hereinafter called “reference frames”). The predicted block P_{B} is generated using an image in the reference frame corresponding to the block O_{B}. When closed-loop coding is used, the reference frame is not an original input frame but an image reconstructed after quantization/inverse quantization.

There are forward prediction (from a temporally previous frame), backward prediction (from a temporally future frame), and bi-directional prediction depending on the type of a reference frame and direction of prediction. While FIG. 4 shows the residual prediction process using bi-directional prediction, forward or backward prediction may be used. Typically, indices in forward prediction and backward prediction are represented by 0 and 1, respectively.

In step S12, the predicted block P_{B} is subtracted from the block O_{B} to generate a residual block R_{B}. In step S13, the residual block R_{B} is quantized and inversely quantized to obtain a reconstructed block R_{B}′. A prime notation mark (′) is used herein to denote that a block has been reconstructed after quantization/inverse quantization.

In step S14, a predicted block P_{C} for a block O_{C} in a current layer N is generated using neighboring reference frames. The reference frame is a reconstructed image obtained after quantization/inverse quantization. In step S15, the predicted block P_{C} is subtracted from the block O_{C} to generate a residual block R_{C}. In step S16, quantization parameters QP_{B0} and QP_{B1} used in quantizing low layer reference frames and quantization parameters QP_{C0} and QP_{C1} used in quantizing high layer reference frames are used to obtain a scaling factor R_{scale}. A difference in dynamic range occurs due to an image quality difference between a current layer reference frame and a lower layer reference frame. Thus, the difference in dynamic range can be represented as a function of current layer reference frames and lower layer reference frames used in quantization. A method for calculating a scaling factor according to an exemplary embodiment of the present invention will be described later in detail.

Throughout this specification, QP denotes a quantization parameter and subscripts B, 0, and C, 1 denote indices of forward and backward reference frames, respectively.

In step S17, the reconstructed residual R_{B}′ obtained in the step S13 is multiplied by the scaling factor R_{scale}. In step S18, the product (R_{scale}×R_{B}′) is subtracted from the residual block R_{C} obtained in the step S15 to obtain data R in the current layer for quantization. Finally, in step S19, the data R is quantized.

P_{B}, P_{C}, R_{B}, and R_{C} may have 16*16 pixels or any other macroblock size.

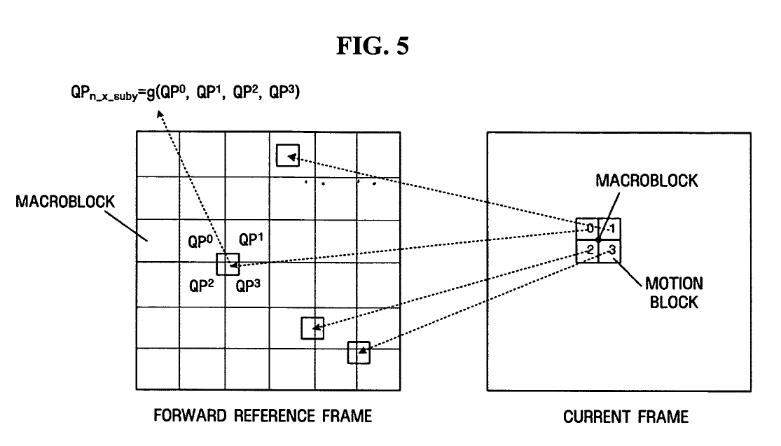

Hereinafter, calculating a scaling factor according to an exemplary embodiment of the present invention will be described in detail with reference to FIG. 5.

As described above, two reference frames may be used for obtaining a predicted block in each layer. FIG. 5 illustrates an example of calculating a quantization parameter QPₙ_{_{—}}ₓ_{_{—}}_{suby} that is representative of a block (‘motion block’) that is the smallest unit for obtaining a motion vector based on a forward reference frame (“motion block representing parameter” or “first representative value”). In H.264, the motion block may have a block size of 16×16, 16×8, 8×16, 8×8, 8×4, 4×8, or 4×4.

The method illustrated in FIG. 5 can also apply to a backward reference frame. Subscripts n and x respectively denote an index of a layer and a reference list index that may have a value of 0 or 1 depending on the direction of prediction. Subscripts sub and y respectively denote the abbreviation and index of a motion block.

A macroblock in a current frame contains at least one motion block. For example, assuming that the macroblock consists of four motion blocks (to be denoted by “y” throughout the specification) having indices of 0 through 3, the four motion blocks match regions on a forward reference frame by motion vectors obtained through motion estimation. In this case, each motion block may overlap one, two, or four macroblocks in the forward reference frame. For example, as illustrated in FIG. 5, the motion block having an index y of 0 overlaps four macroblocks in the forward reference frame. Similarly, the motion block having an index y of 3 in the figure also overlaps four macroblocks, whereas the motion block having an index y of 2 overlaps only two macroblocks in the forward reference frame, etc.

If Qp⁰, Qp¹, Qp², and QP³ denote quantization parameters for the four macroblocks, respectively, a motion block representing parameter QPₙ_{_{—}}ₒ_{_{—}}_{sub0} for the motion block 0 may be represented as a function g of the four quantization parameters Qp⁰, Qp¹, Qp², and QP³.

Various operations such as simple averaging, median, and area weighted averaging may be used in obtaining the motion block representing parameter QPₙ_{_{—0}}_{_{—}}_{sub0} from the four quantization parameters QP⁰, QP¹, Qp², and QP³ Herein, area weighted averaging is used by way of illustration.

The process of calculating the motion block representing parameter QPₙ_{_{—}}₀_{_{—}}_{suby} through weighted averaging is represented by Equation (1) below.

$${QP}_{n\_x \_suby} = \frac{1}{areaMBy} {\sum }_{z = 0}^{Z - 1} ( areaOLy * {QP}^{z} ) \qquad ( 1 )$$

In Equation (1), areaMBy denotes the area of motion block y, areaOLy denotes the overlapped area of part y, and Z denotes the number of macroblocks in the reference frame that overlap the motion block.

After calculating the motion block representing parameter QPₙ_{_{—}}ₓ_{_{—}}_{suby} as described above, a quantization parameter QPₙ representative of a macroblock (“macroblock representing parameter” or “second representative value”) will be calculated. Various operations may be used in obtaining the macroblock representing parameter QPₙ from QPₙ_{_{—}}ₓ_{_{—}}_{suby} for the plurality of motion blocks. Herein, area weighted averaging is used by way of illustration. The macroblock representing parameter is defined by Equation (2) below:

$${QP}_{n} = \frac{1}{X} {\sum }_{x = 0}^{X - 1} [ \frac{1}{areaMB} {\sum }_{y = 0}^{{Y}_{x} - 1} ( areaMBy * {QP}_{n\_x \_suby} ) ] \qquad ( 2 )$$

In Equation (2), areaMB denotes the area of macroblock, areaMBy denotes the area of macroblock y,X denotes the number of reference frames and Yₓ denotes the number of indices of motion blocks in a macroblock with respect to a reference index list x. In unidirectional prediction (forward or backward prediction), X is 1, while X is 2 in bi-directional prediction. For the macroblock shown in FIG. 5, Yₓ (Y₀ in the forward prediction) is 4 because the macroblock is segmented into four motion blocks.

After determining the macroblock representing parameter QPₙ as shown in Equation (2), a scaling factor is determined in order to compensate for a dynamic range difference between residual signals that occurs due to a difference between quantization parameters for a current layer reference frame and a lower layer reference frame.

The same process of calculating motion block representing parameter and macroblock representing parameter applies to the lower layer. However, a region in the lower layer corresponding to a macroblock in the current layer may be smaller than the macroblock in the current layer when the current layer has a higher resolution than the lower layer. This is because a residual signal in the lower layer must be upsampled for residual prediction. Thus, QPₙ₋₁ for the lower layer is obtained based on the region in the lower layer corresponding to the current layer macroblock and motion blocks in the region. In this case, QPₙ₋₁ for the lower layer is regarded as a macroblock representing parameter because it is calculated using a region corresponding to a current macroblock although the region does not have the same area as the macroblock.

When QPₙ and QPₙ₋₁ respectively denote macroblock representing parameters for the current layer and lower layer, a scaling factor R_{scale} can be defined by Equation (3) below:

$${R}_{Scale} = \frac{{QS}_{n}}{{QS}_{n - 1}} \qquad ( 3 )$$

In Equation (3), QSₙ and QSₙ₋₁ denote quantization steps corresponding to quantization parameters QPₙ and QPₙ₋₁.

A quantization step is a value actually applied during quantization while a quantization parameter is an integer index corresponding one-to-one to the quantization step. The QSₙ and QSₙ₋₁ are referred to as “representative quantization steps”. The representative quantization step can be interpreted as an estimated value of quantization step for a region on a reference frame corresponding to a block in each layer.

Because a typical quantization parameter has an integer value but QPₙ and QPₙ₋₁ have a real value, QPₙ and QPₙ₋₁ should be converted into an integer value if necessary. For conversion, QPₙ and QPₙ₋₁ may be rounded off, rounded up, or rounded down to the nearest integer. The real-valued QPₙ and QPₙ₋₁ may also be used to interpolate QSₙ and QSₙ₋₁, respectively. In this case, QSₙ and QSₙ₋₁ may have a real value interpolated using QPₙ and QPₙ₋₁.

As shown in Equations (1) through (3), quantization parameters are used to calculate a subblock representing parameter and a macroblock representing parameter. Alternatively, quantization steps may be directly applied instead of the quantization parameters. In this case, the quantization parameters Qp⁰, Qp¹, Qp², and QP³ shown in FIG. 5 will be replaced with quantization steps QS⁰, QS¹, QS², and QS³. In such a case, the process of converting quantization parameters to quantization steps in Equation (3) may be omitted.

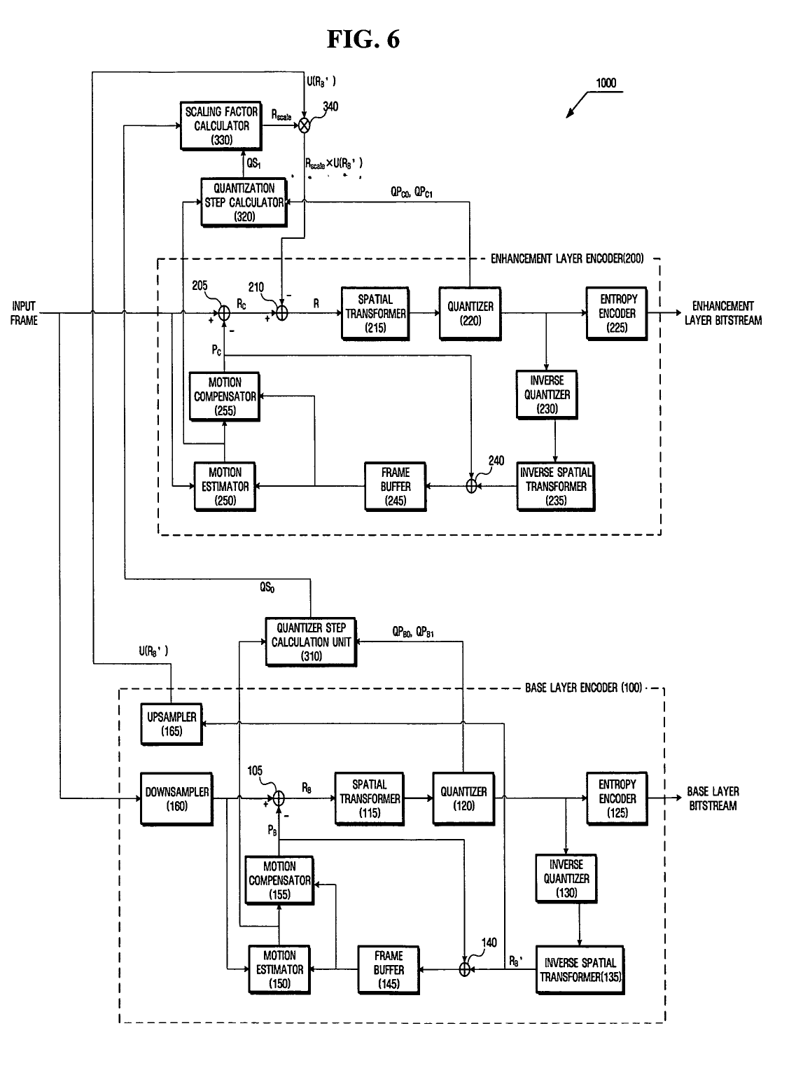

FIG. 6 is a diagram of a multi-layer video encoder 1000 according to an exemplary embodiment of the present invention. Referring to FIG. 6, the multi-layer video encoder 1000 comprises an enhancement layer encoder 200 and a base layer encoder 100. The operation of the multi-layer video encoder 1000 will now be described with reference to FIG. 6.

Using the enhancement layer encoder 200 as a starting point, a motion estimator 250 performs motion estimation on a current frame using a reconstructed reference frame to obtain motion vectors. At this time, not only the motion vectors but also a macroblock pattern representing types of motion blocks forming a macroblock can be determined. The process of determining a motion vector and a macroblock pattern involves comparing pixels (subpixels) in a current block with pixels (subpixels) of a search area in a reference frame and determining a combination of motion vector and macroblock pattern with a minimum rate-distortion (R-D) cost.

The motion estimator 250 sends motion data such as motion vectors obtained as a result of motion estimation, a motion block type, and a reference frame number to an entropy coding unit 225.

The motion compensator 255 performs motion compensation on a reference frame using the motion vectors and generates a predicted block (P_{c}) corresponding to a current frame. In a case of using a two-way reference, the predicted block (P_{c}) may be generated by averaging a region corresponding to a motion block in two reference frames.

The subtractor 205 subtracts the predicted block (P_{c}) in a current macroblock, and generates a residual signal (R_{c}).

Meanwhile, in a base layer encoder 100, a motion estimator 150 performs motion estimation to the macroblock of a base layer provided by the downsampler 160, and calculates motion vector and macroblock pattern using a similar method as described with reference to the enhancement layer encoder 200. A motion compensator 155 generates a predicted block (P_{B}) by motion compensation of reference frame (the reconstructed frame) of the base layer using the calculated motion vector.

The subtractor 105 subtracts the predicted block (P_{B}) in the macroblock, and generates residual signal (R_{B}).

A spatial transformer 115 performs spatial transform on a frame in which temporal redundancy has been removed by the subtractor 105 to create transform coefficients. A Discrete Cosine Transform (DCT) or a wavelet transform technique may be used for the spatial transform. A DCT coefficient is created when DCT is used for the spatial transform while a wavelet coefficient is produced when wavelet transform is used.

A quantizer 120 performs quantization on the transform coefficients obtained by the spatial transformer 115 to create quantization coefficients. Here, quantization is a methodology to express the transformation coefficient expressed in an arbitrary real number as a finite number of bits. Known quantization techniques include scalar quantization, vector quantization, and the like. A simple scalar quantization technique is performed by dividing a transform coefficient by a value of a quantization table mapped to the coefficient and rounding the result to an integer value.

An entropy encoder 125 losslessly encodes the quantization coefficients generated by the quantizer 120 and a prediction mode selected by a motion estimator 150 into a base layer bitstream. Various coding schemes such as Huffinan Coding, Arithmetic Coding, and Variable Length Coding may be employed for lossless coding.

The inverse quantizer 130 performs inverse quantization on the coefficient quantized by the quantizer 120. And, the inverse spatial transformer 135 performs inverse spatial transform on the inversely quantized result that is then sent to the adder 140.

The adder 140 adds the predicted block (P_{B}′) to a signal (a reconstructed residual signal R_{B}′) received by the inverse spatial transformer 135, thereby reconstructing a macroblock of a base layer. The reconstructed macroblocks are combined to form a frame or a slice, and thereby those are stored in a frame buffer 145 for a time. The stored frame is provided in the motion estimator 150 and the motion compensator 155 to be used with the reference frame of other frames again.

The reconstructed residual signal (R_{B}′) provided from the inverse spatial transformer 135 is used for residual prediction. When a base layer has a different resolution than an enhancement layer, the residual signal (R_{B}′) must be upsampled by an upsampler 165 first.

A quantization step calculation unit 310 uses quantization parameters QP_{B0} and QP_{B1} for a base layer reference frame received from the quantizer 120 and motion vectors received from the motion estimator 150 to obtain a representative quantization step QS₀ using the Equations (1) and (2). Similarly, a quantization step calculator 320 uses quantization parameters QP_{C0} and QP_{C1} for an enhancement layer reference frame received from a quantizer 220 and motion vectors received from a motion estimator 250 to obtain a representative quantization step QS₁ using the Equations (1) and (2).

The quantization steps QS₀ and QS₁ are sent to a scaling factor calculator 330 that then divides QS₁ by QS₀ in order to calculate a scaling factor R_{scale}. A multiplier 340 multiplies the scaling factor R_{scale} by U(R_{B}′) provided by the base layer encoder 100.

A subtractor 210 subtracts the product from residual signal R_{C} output from a subtractor 205 to generate final residual signal R. Hereinafter, the final residual signal R is referred to as a difference signal in order to distinguish it from other residual signals R_{C} and R_{B} obtained by subtracting a predicted signal from an original signal.

The difference signal R is spatially transformed by a spatial transformer 215 and then the resulting transform coefficient is fed into the quantizer 220. The quantizer 220 applies quantization to the transform coefficient. When the magnitude of the difference signal R is less than a threshold, the spatial transform will be skipped.

The entropy encoder 225 losslessly encodes the quantized results generated by the quantizer 220 and motion data provided by a motion estimator 250, and generates an output enhancement layer bitstream.

Since the operations of the inverse quantizer 230, the inverse spatial transformer 235, the adder 240 and the frame buffer 245 of the enhancement layer encoder 200 are the same as the inverse quantizer 130, the inverse spatial transformer 135, the adder 140 and the frame buffer 145 of the base layer encoder 100 discussed previously, a repeated explanation thereof will not be given.

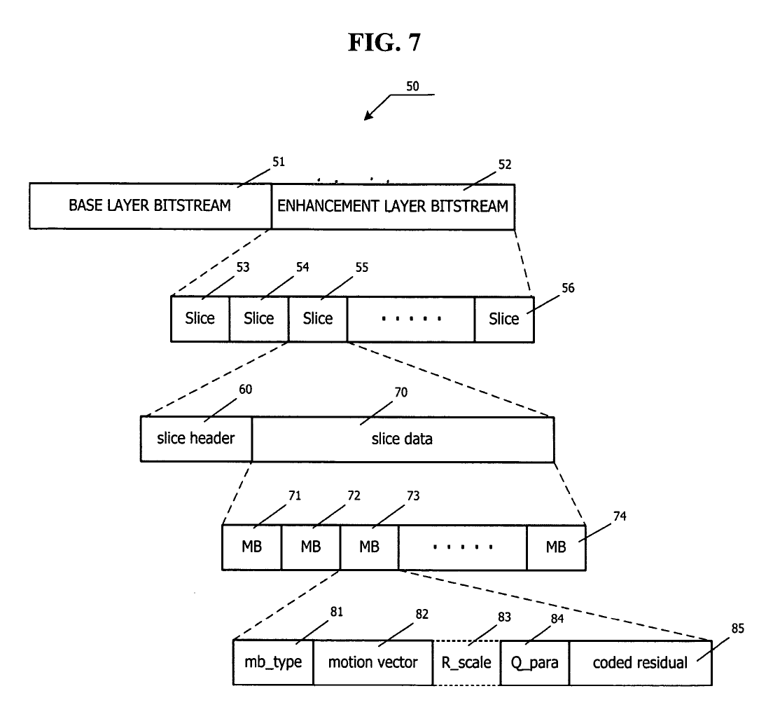

FIG. 7 illustrates the structure of a bitstream 50 generated by the video encoder 1000. The bitstream 50 consists of a base layer bitstream 51 and an enhancement layer bitstream 52. Each of the base layer bitstream 51 and the enhancement layer bitstream 52 contains a plurality of frames or slices 53 through 56. In general, in the H.264 or Scalable Video Coding (SVC) coding standard, a bitstream is encoded in slices rather than in frames. Each slice may have the same size as one frame or macroblock.

One slice 55 includes a slice header 60 and slice data 70 containing a plurality of macroblocks MB 71 through 74.

One macroblock 73 contains an mb_type field 81, a motion vector field 82, a quantization parameter (Q_para) field 84, and a coded residual field 85. The macroblock 85 may further contain a scaling factor field R_scale 83.

The mb_type field 81 is used to indicate a value representing the type of macroblock 73. That is, the mb_type field 81 specifies whether the current macroblock 73 is an intra macroblock, inter macroblock, or an intra BL macroblock. The motion vector field 82 indicates a reference frame number, the pattern of the macroblock 73, and motion vectors for motion blocks. The quantization parameter (Q_para) field 84 is used to indicate a quantization parameter for the macroblock 73. The coded residual field 85 specifies the result of quantization performed for the macroblock 73 by the quantizer 220, i.e., coded texture data.

The scaling factor field 83 indicates a scaling factor R_{scale} for the macroblock 73 calculated by the scaling factor calculator 330. The macroblock 73 may selectively contain the scaling factor field 83 because a scaling factor can be calculated in a decoder like in an encoder. When the macroblock 73 contains the scaling factor field 83, the size of the bitstream 50 may increase but the amount of computations of decoding decreases.

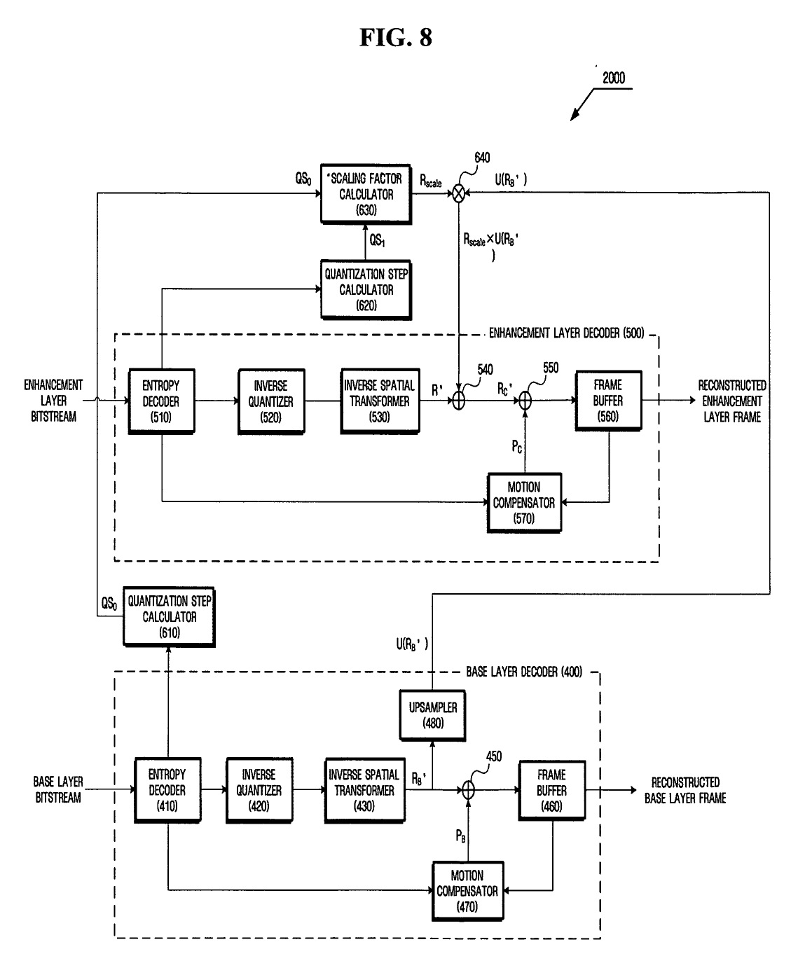

FIG. 8 is a diagram of a multi-layer video decoder 2000 according to an exemplary embodiment of the present invention. Referring to FIG. 8, the video decoder 2000 comprises an enhancement layer decoder 500 and a base layer decoder 400.

Using the enhancement layer decoder 500 as a starting point, an entropy decoder 510 performs lossless decoding that is an inverse operation of entropy encoding for an inputted enhancement layer bitstream 52 to extract motion data, and texture data for the enhancement layer. The entropy decoding unit 510 provides the motion data, and the texture data to a motion compensator 570, and an inverse quantizer 520, respectively.

The inverse quantizer 520 performs inverse quantization on the texture data received from the entropy decoding unit 510. The inverse quantization parameter (the same as that used in the encoder) which is included in the enhancement layer bitstream 52 in FIG. 7 is used.

An inverse spatial transformer 530 performs inverse spatial transform to the results of the inverse quantization. The inverse spatial transform is performed corresponding to the spatial transform at the video encoder. For example, if a wavelet transform is used for spatial transform at the video encoder, the inverse spatial transformer 530 performs inverse wavelet transform. If DCT is used for spatial transform, the inverse spatial transformer 530 performs inverse DCT. After the inverse spatial transform, the difference signal R′ at the encoder is reconstructed.

Meanwhile, an entropy decoder 410 performs lossless decoding that is an inverse operation of entropy encoding for an inputted base layer bitstream 51 to extract motion data, and texture data for the base layer. The texture data are the same as at the enhancement layer decoder 500. A residual signal (R_{B}′) of the base layer is reconstructed through an inverse quantizer 420 and an inverse spatial transformer 430.

If a base layer has a lower resolution than an enhancement layer, a residual signal R_{B}′ is subjected to upsampling by an upsampler 480.

A quantization step calculator 610 uses base layer motion vectors and quantization parameters QP_{B0} and QP_{B1} for a base layer reference frame received from the entropy decoder 410 to obtain a representative quantization step QS₀ using the Equations (1) and (2). Similarly, a quantization step calculator 620 uses enhancement layer motion vectors and quantization parameters QP_{C0} and QP_{C1} for an enhancement layer reference frame received from an entropy decoder 510 to obtain a representative quantization step QS₀ using the Equations (1) and (2).

The quantization steps QS₀ and QS₁ are sent to a scaling factor calculator 630 that then divides QS₁ by QS₀ in order to calculate a scaling factor R_{scale}. A multiplier 640 multiplies the scaling factor R_{scale} by U(R_{B}′) provided by the base layer decoder 400.

The adder 540 adds the difference signal R′ output from the inverse spatial transformer 530 to the output of the multiplier 640, thereby reconstructing a residual signal R_{C}′ of an enhancement layer.

The motion compensator 570 performs motion compensation on at least a reference frame using the motion data provided from the entropy decoding unit 510. After motion-compensation, a generated predicted block (P_{C}) is provided to an adder 550.

An adder 550 adds R_{C}′ and P_{C′} together to reconstruct a current macroblock and then combines the macroblocks together to reconstruct an enhancement layer frame. The reconstructed enhancement layer frame is temporarily stored in a frame buffer 560 before being provided to a motion compensator 570 or being externally output.

Since the operation of the adder 450, the motion compensator 470 and the frame buffer 460 of the base layer decoder 400 are the same as the adder 550, the motion compensator 570 and the frame buffer 560 of the enhancement layer decoder 500, a repeated explanation thereof will not be given.

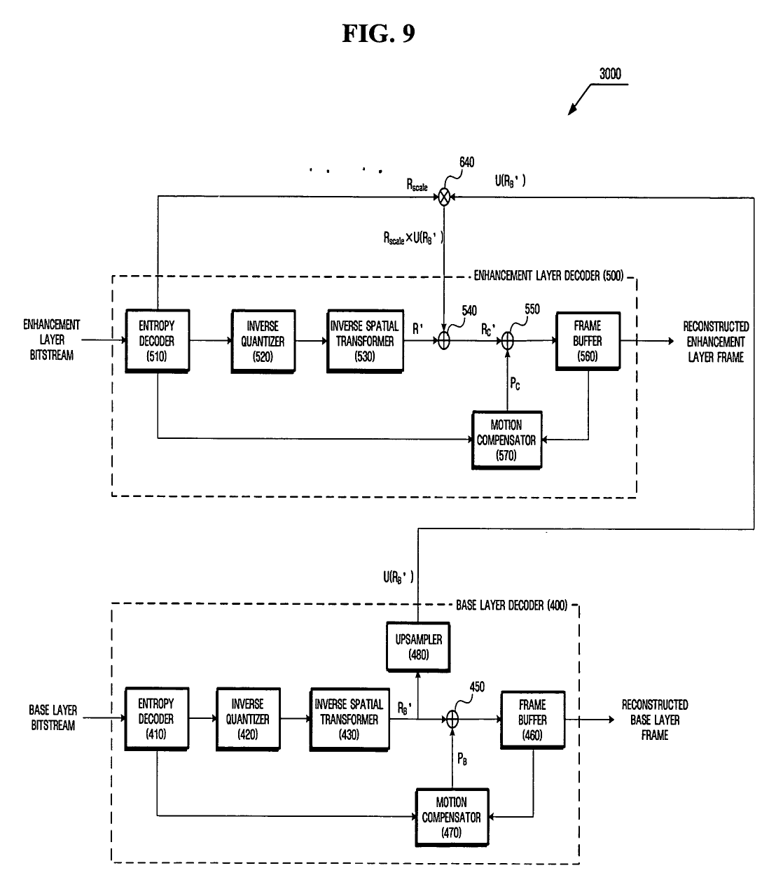

FIG. 9 is a diagram of a multi-layer video decoder 3000 according to another exemplary embodiment of the present invention. Unlike in the video decoder 2000 of FIG. 8, the video decoder 3000 does not include quantization step calculators 610 and 620 or the scaling factor calculator 630 required for obtaining a scaling factor. That is, a scaling factor R_{scale} for a current macroblock in an enhancement layer bitstream is delivered directly to a multiplier 640 for subsequent operation. The operation of the other blocks, however, is the same, and hence will not be described again.

If the scaling factor R_{scale} is received directly from an encoder, the size of a received bitstream may increase but the number of computations needed for decoding may be decreased by a certain extent. The video decoder 3000 may be suitably used for a device having low computation capability compared to its reception bandwidth.

In the foregoing description, it has been described that the video encoder and the video decoder are configured by two layers of a base layer and an enhancement layer, respectively. However, this is only by way of an example, and the inventive concept may also be used and applied to more than 3 layers by those of ordinary skill in the art in light of the above teachings.

In FIGS. 6, 8, and 9, various components mean, but are not limited to, software or hardware components, such as Field Programmable Gate Arrays (FPGAs) or Application Specific Integrated Circuits (ASICs), which perform certain tasks. The components may advantageously be configured to reside on various addressable storage media and configured to execute on one or more processors. The functionality provided for in the components and modules may be combined into fewer components and modules or further separated into additional components and modules.

In the foregoing description, residual prediction according to exemplary embodiments of the present invention is applied to reduce redundancy between layers in inter prediction. However, the residual prediction can be applied to any type of prediction that involves generating a residual signal. To give a non-limiting example, the residual prediction of the present invention can be applied between residual signals generated by intra prediction or between residual signals at different temporal positions in the same layer.

The inventive concept of exemplary embodiments of the present invention can efficiently remove residual signal energy during residual prediction by compensating for a dynamic range difference between residual signals that occurs due to a difference between quantization parameters for predicted signals in different layers. The reduction in residual signal energy can decrease the amount of bits generated during quantization.

While the present invention has been particularly shown and described with reference to certain exemplary embodiments thereof, it will be understood by those of ordinary skill in the art that various changes in form and details may be made therein without departing from the spirit and scope of the present inventive concept as defined by the following claims. Therefore, it is to be understood that the above-described exemplary embodiments have been provided only in a descriptive sense and will not be construed as placing any limitation on the scope of the invention.

What is claimed is:

1. A residual prediction method comprising:
calculating a first residual signal,
calculating a second residual signal;
performing scaling by multiplying the second residual signal by a scaling factor; and
calculating a difference between the first residual signal and the scaled second residual signal.

2. The residual predication method of claim 1, wherein the first residual signal is for a current layer block, and the second residual signal is for a lower layer block corresponding to the current layer block.

3. The residual prediction method of claim 2, further comprising upsampling the second residual signal,
wherein in the performing of the scaling, the second residual signal is the upsampled second residual signal.

4. The residual prediction method of claim 2, wherein the current layer block is a macroblock.

5. The residual prediction method of claim 2, wherein the calculating of the first residual signal for the current layer block comprises:
generating a predicted block for the current layer block using a current layer reference frame; and
subtracting the predicted block from the current layer block.

6. The residual prediction method of claim 5, wherein the current layer reference frame is one of a forward reference frame, a backward reference frame, and a bi-directional reference frame.

7. The residual prediction method of claim 5, wherein the current layer reference frame is generated after quantization and inverse quantization.

8. The residual prediction method of claim 2, wherein the calculating of the second residual signal for the lower layer block comprises:
generating a predicted block for the lower layer block using a lower layer reference frame;
subtracting the predicted block from the lower layer block; and
quantizing and inversely quantizing the result of the subtraction.

9. The residual prediction method of claim 8, wherein the lower layer reference frame is generated after quantization and inverse quantization.

10. The residual prediction method of claim 2, wherein in the performing of scaling, the scaling factor is obtained by calculating a first representative quantization step for the current layer block, calculating a second representative quantization step for the lower layer block, and dividing the first representative quantization step by the second representative quantization step, wherein the first and second representative quantization steps are estimated values of quantization steps for regions on reference frames corresponding to the current layer block and the lower layer block.

11. The residual prediction method of claim 10, wherein the first and second representative quantization steps are obtained by calculating a first representative value from quantization parameters for macroblocks in a reference frame overlapping a certain motion block in the current layer block, calculating a second representative value for the current layer block from the first representative value, and converting the second representative value into a corresponding representative quantization step.

12. The residual prediction method of claim 11, wherein the calculating of the first representative value comprises calculating an average of the quantization parameters by weighting the overlapped areas of the macroblocks.

13. The residual prediction method of claim 11, wherein the calculating of the second representative value comprises calculating an average of the first representative values by weighting a size of the motion block.

14. The residual prediction method of claim 10, wherein the first and second representative quantization steps are obtained by calculating a first representative value from quantization steps for macroblocks in a reference frame overlapping a certain motion block in the current layer block, and calculating a second representative value for the current layer block from the first representative values.

15. A multi-layer video encoding method comprising:
calculating a first residual signal;
calculating a second residual signal;
performing scaling by multiplying the second residual signal by a scaling factor; and
calculating a difference between the first residual signal and the scaled second residual signal; and
quantizing the difference.

16. The multi-layer video encoding method of claim 15, wherein the first residual signal is for a current layer block, and the second residual signal is for a lower layer block corresponding to the current layer block.

17. The multi-layer video encoding method of claim 16, further comprising performing spatial transform on the difference before the quantizing of the difference.

18. The multi-layer video encoding method of claim 16, further comprising upsampling the second residual signal, wherein the second residual signal of the performing of the scaling is the upsampled second residual signal.

19. The multi-layer video encoding method of claim 16, wherein the calculating of the first residual signal for the current layer block comprises:
generating a predicted block for the current layer block using a current layer reference frame; and
subtracting the predicted block from the current layer block.

20. The multi-layer video encoding method of claim 16, wherein the calculating of the second residual signal for the lower layer block comprises:
generating a predicted block for the lower layer block using a lower layer reference frame;
subtracting the predicted block from the lower layer block; and
quantizing and inversely quantizing the result of the subtraction.

21. The multi-layer video encoding method of claim 16, wherein in the performing of scaling, the scaling factor is obtained by calculating a first representative quantization step for the current layer block, calculating a second representative quantization step for the lower layer block, and dividing the first representative quantization step by the second representative quantization step, wherein the first and second representative quantization steps are estimated values of quantization steps for regions on reference frames corresponding to the current layer block and the lower layer block.

22. The multi-layer video encoding method of claim 21, wherein the calculating of the first and second representative quantization steps comprises:
calculating a first representative value from quantization parameters for macroblocks in a reference frame overlapping a certain motion block in the current layer block;
calculating a second representative value for the current layer block from the first representative value; and
converting the second representative value into a corresponding representative quantization step.

23. The multi-layer video encoding method of claim 16, wherein the first and second representative quantization steps are obtained by calculating a first representative value from quantization steps for macroblocks in a reference frame overlapping a certain motion block in the current layer block, and calculating a second representative value for the current layer block from the first representative values.

24. A method for generating a multi-layer video bitstream including generating a base layer bitstream and generating an enhancement layer bitstream, wherein the enhancement layer bitstream contains at least one macroblock and each macroblock comprises a field indicating a motion vector, a field specifying a coded residual, and a field indicating a scaling factor for the macroblock, and
wherein the scaling factor is used to make a dynamic range of a residual signal for a base layer block substantially equal to a dynamic range of a residual signal for an enhancement layer block.

25. The method of claim 24, wherein the macroblock further includes a quantization parameter for the macroblock.

26. The method of claim 24, wherein the enhancement layer bitstream consists of a plurality of slices and each slice contains at least one macroblock.

27. A multi-layer video decoding method comprising:
reconstructing a difference signal from an input bitstream;
reconstructing a first residual signal from the input bitstream;
performing scaling by multiplying the first residual signal by a scaling factor; and
adding the reconstructed difference signal and the scaled first residual signal together and reconstructing a second residual signal.

28. The multi-layer video decoding method of claim 27, wherein the difference signal is for a current layer block, the first residual signal is for a lower layer block, and the second residual signal is for the current layer block.

29. The multi-layer video decoding method of claim 28, further comprising adding together a predicted block for the current layer block, the result of addition, and the second residual signal.

30. The multi-layer video decoding method of claim 28, further comprising upsampling the first residual signal,
wherein in the performing of the scaling, the first residual signal is the upsampled first residual signal.

31. The multi-layer video decoding method of claim 28, wherein the reconstructing of the difference signal and the reconstructing of the first residual signal comprise inverse quantization and an inverse spatial transform.

32. The multi-layer video decoding method of claim 28, wherein the current layer block is a macroblock.

33. The multi-layer video decoding method of claim 28, wherein the bitstream contains the scaling factor.

34. The multi-layer video decoding method of claim 28, wherein in the performing of scaling, the scaling factor is obtained by calculating a first representative quantization step for the current layer block, calculating a second representative quantization step for the lower layer block, and dividing the first representative quantization step by the second representative quantization step, wherein the first and second representative quantization steps are estimated values of quantization steps for regions on reference frames corresponding to the current layer block and the lower layer block.

35. The multi-layer video decoding method of claim 34, wherein the first and second representative quantization steps are obtained by calculating a first representative value from quantization parameters for macroblocks in a reference frame overlapping a certain motion block in the current layer block, calculating a second representative value for the current layer block from the first representative value, and converting the second representative value into a corresponding representative quantization step.

36. The multi-layer video decoding method of claim 35, wherein the calculating of the first representative value comprises calculating an average of the quantization parameters by weighting the overlapped areas of the macroblocks.

37. The multi-layer video decoding method of claim 35, wherein the calculating of the second representative value comprises calculating an average of the first representative values by weighting a size of the motion block.

38. The multi-layer video decoding method of claim 34, wherein the first and second representative quantization steps are obtained by calculating a first representative value from quantization steps for macroblocks in a reference frame overlapping a predetermined motion block in the current layer block, and calculating a second representative value for the current layer block from the first representative values.

39. A multi-layer video encoder comprising:
means for calculating a first residual signal;
means for calculating a second residual signal;
means for performing scaling by multiplying the second residual signal by a scaling factor; and
means for calculating a difference between the first residual signal and the scaled second residual signal; and
means for quantizing the difference.

40. The multi-layer video encoder of claim 39, wherein the first residual signal is for a current layer block, and the second residual signal is for a lower layer block corresponding to the current layer block.

41. A multi-layer video decoder comprising:
means for reconstructing a difference signal from an input bitstream;
means for reconstructing a first residual signal from the input bitstream;
means for performing scaling by multiplying the first residual signal by a scaling factor; and
means for adding the reconstructed difference signal and the scaled first residual signal together and reconstructing a second residual signal.

42. The multi-layer video decoder of claim 41, wherein the difference signal is for a current layer block, the first residual signal is for a lower layer block, and the second residual signal is for the current layer block.
